(19) United States
(12) Patent Application Publication
(10) Pub. No.: US 2013/0173110 A1
(43) Pub. Date: Jul. 4, 2013

(54) METHOD AND DEVICE FOR OPERATING A DRIVER ASSISTANCE SYSTEM OF A VEHICLE

(71) Applicant: Thomas Fuehrer, Stuttgart-Weilimdorf (DE)

(72) Inventor: Thomas Fuehrer, Stuttgart-Weilimdorf (DE)

(21) Appl. No.: 13/713,053

(22) Filed: Dec. 13, 2012

(30) Foreign Application Priority Data
Jan. 4, 2012 (DE) 10 2012 200 068.2

(51) Int. Cl. G05D 1/00

(52) U.S. Cl. CPC G05D 1/00
USPC 701/23

(57) ABSTRACT

A method for operating a driver assistance system of a vehicle, including receiving data transmitted to the vehicle; using the received data for a decision as to whether or not the driver assistance system is to provide a driver assistance function, characterized by archiving of the data used.

Moreover, the invention relates to a driver assistance system for a vehicle, a system for operating a driver assistance system for a vehicle, and a computer program are described.

### CROSS REFERENCE

The present application claims the benefit under 35 U.S.C. §119 of German Patent Application No. DE 102012200068.2 filed on Jan. 4, 2012, which is expressly incorporated herein by reference in its entirety.

### FIELD

The present invention relates to a method and a device for operating a driver assistance system of a vehicle. Furthermore, the present invention relates to a driver assistance system for a vehicle, and to a system for operating a driver assistance system for a vehicle. The present invention furthermore relates to a computer program.

### BACKGROUND INFORMATION

Driver assistance systems as such are available. For instance, they can receive information from an external server. In particular, this information may be used for the decision as to whether or not a driver assistance system should intervene in a vehicle operation.

Especially for an accident analysis, it is advantageous to know which data the driver assistance system has used for its decision.

### SUMMARY

An object of the present invention is to provide a better method for operating a driver assistance system of a vehicle.

The object may also include providing a corresponding device for operating a driver assistance system of a vehicle.

An objective of the present invention may also include providing a corresponding driver assistance system for a vehicle as well as a corresponding system for operating a driver assistance system for a vehicle, and a corresponding computer program.

According to one aspect, an example method for operating a driver assistance system of a vehicle is provided. In this method, data transmitted to the vehicle are received and used for a decision as to whether or not the driver assistance system is to provide a driver assistance function. The used data are archived.

According to one further aspect, an example device for operating a driver assistance system of a vehicle is provided. The device includes a receiver to receive data transmitted to the vehicle. Furthermore, the device has an archiver unit to archive the data that were used for a decision as to whether a driver assistance function is to be provided.

According to a still further aspect, an example driver assistance system for a vehicle is provided, which includes the device for operating a driver assistance system of a vehicle.

According to a still further aspect, an example system for operating a driver assistance system for a vehicle is provided, the system including the driver assistance system for a vehicle, and the archiver unit having a transmitter for transmitting the utilized data to an external memory device situated externally to the vehicle. In addition, the system includes the external memory device situated externally to the vehicle.

According to another aspect, an example computer program is provided, which includes program code to execute the example method for operating a driver assistance system for a vehicle when the computer program is run on a computer.

In accordance with the present invention, especially the data transmitted to the vehicle that was used for a decision as to whether the driver assistance system is to provide a driver assistance function is archived. Generally, such data transmitted to the vehicle are volatile data. In other words, the data are normally deleted after use or overwritten with new data transmitted to the vehicle, so that the data would no longer be available for a later analysis. In accordance with the present invention, however, these data are archived prior to a potential deletion or an overwriting process, so that the data may advantageously be available for subsequent analyses.

According to one specific development, still further data are used for the decision as to whether or not the driver assistance system is to provide a driver assistance function. Such further data, for example, may include environmental sensor data from environmental sensors for detecting a vehicle environment of the vehicle. In other words, an environmental sensor system of the vehicle senses a vehicle environment and corresponding environmental sensor data are taken into account in the decision. Radar or video sensors, for example, may be environmental sensors.

According to one specific embodiment, the environmental sensor system, which also may simply be referred to as sensor system in abbreviated form, includes one or more radar sensor(s). In particular, the sensor system may include an ultrasonic sensor or multiple ultrasonic sensors. The sensor system preferably may include a video camera, especially 3D—or stereo video camera, an environmental camera system for recording images of a 360° environment of a vehicle, a Lidar sensor, a flight time sensor and/or a photo mixing detector, also known as photonic mixing device (PMD) sensor. A PMD sensor in particular is able to be employed as image sensor in TOF cameras, TOF being the abbreviation of “time of flight” and based on light-propagation time methods. The video camera may be a stereo video camera, in particular.

Such additional data especially may also include data from inertial sensors of the vehicle. For example, such inertial sensors include acceleration sensors and rate-of-rotation sensors. Preferably, the inertial sensors are developed to record or measure a vehicle speed, a vehicle acceleration, and/or a vehicle rate of rotation.

In one specific embodiment the additional data may be archived. That allows an even more precise retroactive analysis. It may be provided, in particular, that only the additional data that were used for the decision are archived. This advantageously saves memory space. As a result, in particular the data transmitted to the vehicle and, furthermore, the additional data are archived.

The data transmitted to the vehicle preferably are produced by sensor systems that include environmental sensors to sense and record a vehicle environment, and/or by means of inertial sensors of further vehicles, and transmitted directly to the vehicle and/or to a central server, which then is able to transmit the data to the vehicle. The communication between the vehicle and the additional vehicles may be carried out in particular by means of the car-to-car communication method. Specifically, the communication between the vehicle and the central server is able to take place using the car-to-infrastructure communication method and/or a mobile radio communication method. The data sent to the vehicle are transmittable to the vehicle via the Internet and/or via a cloud system and/or a social network, for example.

The fact that the data used by the driver assistance system, in this case especially the data transmitted to the vehicle and/or, specifically, the additional data, are archived advantageously makes it possible to analyze and evaluate these data also at a later time, especially following an accident of the vehicle. As a result, it is advantageously possible to determine whether or not the used data are correct. In this regard, in particular the cause of an accident is able to be determined in an advantageous manner. The decision whether a driver assistance function is to be provided is made by a central control, in particular. Preferably, the driver assistance system itself may make the decision, especially by means of a driver-assistance system control.

Data, i.e., especially the data transmitted to the vehicle and preferably the additional data within the meaning of the present invention, specifically include vehicle environment data, which especially include information about the vehicle surroundings. Such information may pertain to physical objects, for instance. A physical object may be, for instance, a traffic sign, a signal system, another vehicle or a boundary post of the street. The data relating to the vehicle surroundings in particular encompass physical characteristics or properties of the road, e.g., a road width, a lane width, curve radii, and/or exits. In the case of stationary physical objects, in particular, the individual position and dimensions are stored in the vehicle surroundings data as well. Vehicle surroundings data especially may also include information about a current situation, e.g., that a construction site with changed road characteristics is located at a particular position. Vehicle surroundings data in particular can also include road lane data, which, for instance, contain information about the color of the road lines. Vehicle surroundings data within the sense of the present invention especially include image and/or video data and/or radar data, and/or ultrasonic data. The data in particular is assigned a corresponding position in relation to physical objects of the vehicle surroundings.

A driver assistance system within the meaning of the present invention especially denotes a system which is able to intervene, in semi-autonomous or autonomous manner, in a drive system and/or a control system such as a gas system or a brake system, and/or a steering system and/or a signaling system of the vehicle. A driver assistance system within the meaning of the present invention in particular is also able to warn a driver shortly before or during a critical situation, using a corresponding man-machine interface.

According to one specific embodiment, a driver assistance system may be, for example, an anti-lock braking system, an electronic stability program, an adaptive high-beam assistant, a night-vision assistant, a brake assistant, an automatic emergency braking system, a Tempomat, a distance control Tempomat (also known as “adaptive cruise control ACC”), a lane detection system, a lane-keeping assistance system, a lane change assistance system, an electronic stability program system, or a parking assistance system. Preferably, it is also possible to provide multiple driver assistance systems, which may have the same or a different design, in particular.

A driver assistance function in particular denotes the function that the driver assistance system is able to provide in order to aid or support the driver or, in particular, to intervene in a vehicle operation. When the driver assistance system makes its driver assistance function available in that regard, an intervention in a vehicle operation takes place, in particular.

According to one specific embodiment, only those data are archived that were used within a time interval that includes an instant at which the driver assistance function was made available. In other words, not all used data are archived, but specifically the data that have led to a positive decision with regard to providing the driver assistance function. Positive in this case specifically means that the driver assistance system makes a driver assistance function available. This advantageously reduces a storage requirement for the archiving. In addition, a corresponding data volume is reduced, so that a subsequent analysis of the archived data is advantageously able to be carried out more efficiently and in a shorter time. The instant when the driver assistance function is made available preferably lies at the end of the time interval. This means, in particular, that only those data are archived that were used during a predefined time prior to the instant at which the driver assistance function was made available. In particular, the predefined time may amount to 60 seconds, especially 40 seconds, preferably 20 seconds, e.g., 10 seconds. Specifically, the predefined time may amount to several minutes, such as three minutes, for instance. It may preferably be provided that, following the instant at which the driver assistance function was provided, the correspondingly utilized data are archived for a predefined further time. That is to say, the point at which the function was provided in particular lies within the time interval.

According to another specific embodiment, the archiving includes storing the used data in a memory device situated inside the vehicle. In other words, the used data are stored in the vehicle itself, in particular. The data stored in this manner then may advantageously be read out from the memory device, for instance following an accident. This specific embodiment has the particular advantage that it is realizable in a simple and cost-effective manner.

According to another aspect, the memory device includes a volatile and a permanent memory, the data being stored in the volatile memory and copied from the volatile to the permanent memory when the driver assistance function is made available. A volatile memory within the meaning of the present invention in particular denotes a memory whose information is lost if not refreshed or if the current is turned off. A permanent memory within the meaning of the present invention in particular denotes a memory which holds information that can no longer be changed once it has been stored. That is to say, because of the fact that the used data are copied to a permanent memory when the driver assistance function is provided, the data advantageously remains stored even if a current supply in the vehicle fails, so that the data are advantageously available for a subsequent analysis. As a result, a correspondingly high data security is ensured in an advantageous manner. Preferably, a semi-permanent memory may be provided in place of, or in addition to, the permanent memory. A semi-permanent memory in the sense of the present invention in particular denotes a memory in which the information is able to be stored permanently, but in which the information is also able to be modified. The use of a semi-permanent memory advantageously allows multiple utilizations of the memory, in particular to the effect that the data possibly stored in the semi-permanent memory are also able to be deleted again following a driving period without accidents. As a result, it is advantageously possible to save costs. In particular, it is also possible to use less installation space for the memory device in an advantageous manner.

In another specific embodiment, the archiving includes a transmission of the used data to an external memory device situated externally to the vehicle. That is to say, the external storage device is not situated inside or on the vehicle, but is situated externally to the vehicle. As a result, the fact that the used data are transmitted to the external memory device for archiving makes the data available for analysis even if the vehicle was completely destroyed, such as in an accident. Furthermore, generally, it is technically less complicated to equip an external memory device with a sufficiently large memory, than an internal memory device inside the vehicle itself. Since the data volume arising in the course of driving may vary, it is advantageously avoided that a memory situated inside the vehicle is completely filled, so that it would then be unable to record any further data.

A communication between the vehicle and the external memory device preferably is implemented by means of a wireless communication method. In so doing, for example, a WLAN communication method and/or a mobile radio communication method such as a “Long Term Evolution” (LTE) mobile radio communication method may be involved. A communication between the vehicle and the external memory device is encrypted, in particular, so that unauthorized persons have no access to the data or that an unauthorized access to the data is made much more difficult.

According to one specific embodiment, the archiver unit includes a memory device, which is provided with a volatile and a permanent and/or a semi-permanent memory.

According to another specific embodiment, it is also possible that the archiver unit has a transmitter for transmitting the used data to an external memory device situated externally to the vehicle.

Hereinafter, the present invention will be explained in greater detail with reference to preferred exemplary embodiments.

### BRIEF DESCRIPTION OF THE DRAWINGS

FIG. 1 shows a device for operating a driver assistance system of a vehicle.

FIG. 2 shows a flow chart of a method for operating a driver assistance system of a vehicle.

FIG. 3 shows a driver assistance system.

FIG. 4 shows a system for operating a driver assistance system of a vehicle.

FIG. 5 shows a flow chart of a further method for operating a driver assistance system of a vehicle.

### DETAILED DESCRIPTION OF EXAMPLE EMBODIMENTS

Below, the same reference numerals are used for the same features.

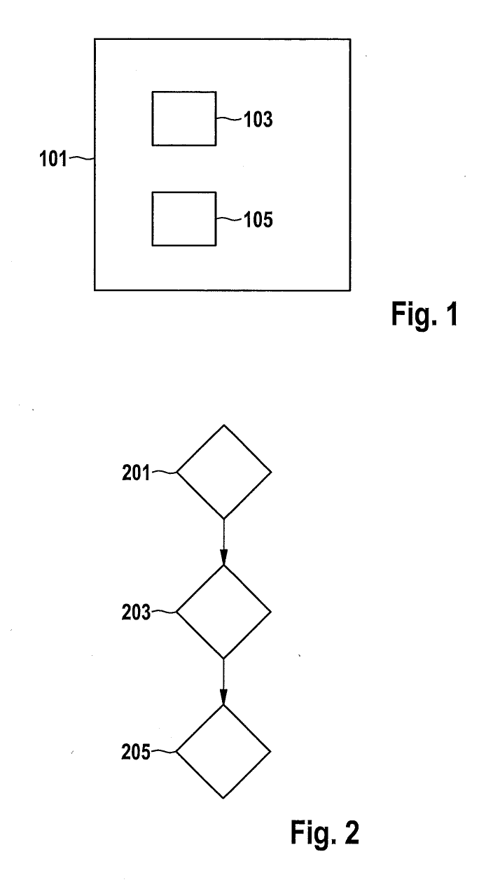

FIG. 1 shows a device 101 for operating a driver assistance system (not shown) of a vehicle (not shown). Device 101 includes a receiver 103 to receive data transmitted to the vehicle. In other words, data are transmitted to the vehicle, which receiver 103 is able to receive, in particular.

Furthermore, device 101 has an archiver unit 105 to archive the data that were used for a decision as to whether or not a driver assistance function is to be provided. This therefore means, in particular, that the received data are at least partially used to decide whether a driver assistance system is to intervene in a driving operation, that is to say, whether it is to provide a driver assistance function. Archiver unit 105 archives the used data, so that the data are advantageously able to be evaluated and analyzed even at a later point in time.

FIG. 2 shows a flow chart of a method for operating a driver assistance system of a vehicle. In this method data transmitted to the vehicle are received in a step 201. According to a step 203, these data are at least partially used for a decision as to whether or not the driver assistance system is to provide a driver assistance function. In other words, the driver assistance system intervenes in a vehicle operation in autonomous or semi-autonomous manner, in accordance with the decision. According to a step 205, the data used for this purpose are archived, so that the data are advantageously available, especially following an accident of the vehicle, for instance for an accident analysis.

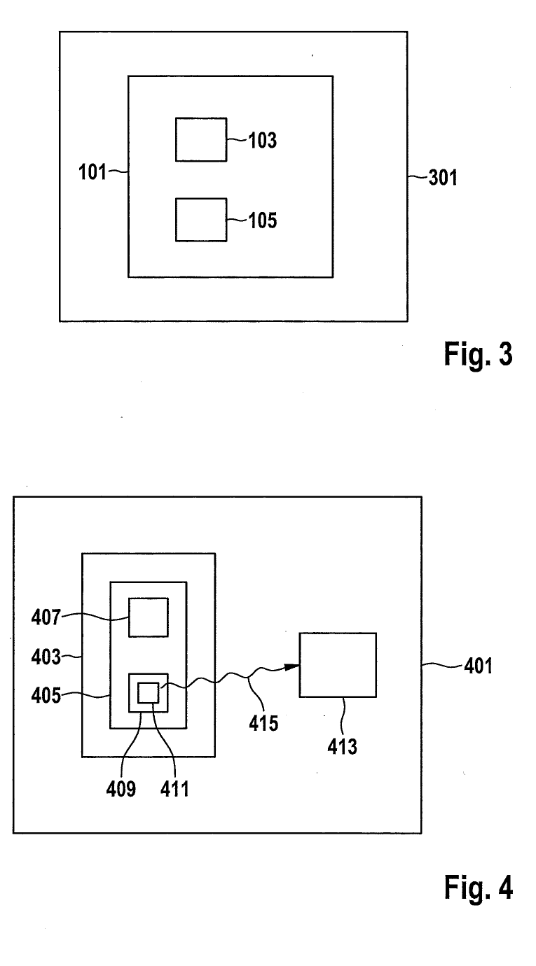

FIG. 3 shows a driver assistance system 301 including device 101 according to FIG. 1.

In one specific embodiment (not shown), archiver unit 105 may include a memory device for storing the data used. The memory device preferably may include a volatile and a permanent, and/or a semi-permanent memory; it is also possible that the data are stored in the volatile memory and copied from the volatile to the permanent or semi-permanent memory only after a driver assistance function has been provided, that is to say, especially in an intervention of the driver assistance system in a vehicle operation.

In another specific embodiment (not shown), it is also possible that archiver unit 105 includes a transmitter for transmitting the used data to an external memory device situated externally to the vehicle. In another specific embodiment (not shown) it may be provided that archiver unit 105 is equipped both with a transmitter and an internal memory device, i.e., a device situated inside the vehicle.

FIG. 4 shows a system 401 for operating a driver assistance system 403 for a vehicle including driver assistance system 403. Driver assistance system 403 has a device 405 for operating driver assistance system 403. Device 405 is equipped with a receiver 407 and an archiver unit 409. Archiver unit 409 includes a transmitter 411, which is able to transmit the used data to an external memory device 413. The transmission is symbolically illustrated by the wavy arrow bearing reference numeral 415.

More specifically, because it is possible to transmit the used data to external memory device 413, i.e., to a memory device situated outside the vehicle, the corresponding data are advantageously available for analysis and evaluation even if the vehicle was completely destroyed in an accident or if an internal memory device of the vehicle was damaged during an accident.

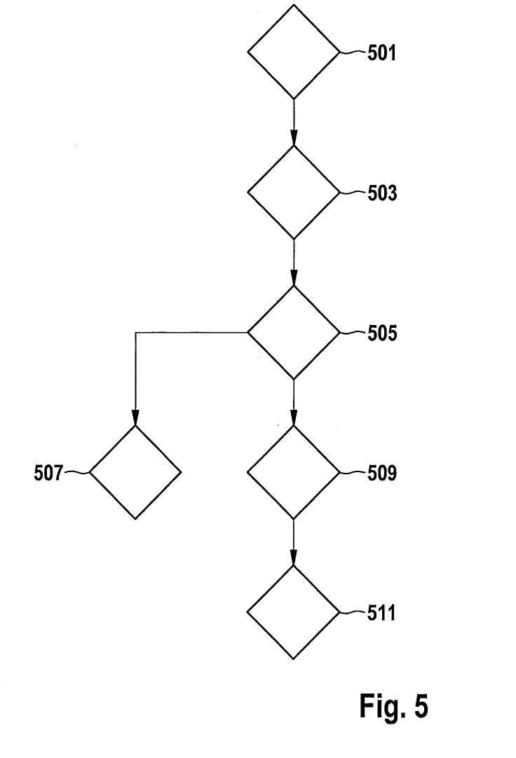

FIG. 5 shows a flow chart of a further method for operating a driver assistance system of a vehicle. According to a step 501, data transmitted to the vehicle are received. According to a step 503, these data are used for the decision whether the driver assistance system is to provide a driver assistance function, especially whether the driver assistance system is to execute an autonomous or semi-autonomous intervention in a vehicle operation.

In a step 505, it is provided that the data used for this purpose are stored in a volatile memory for a predefined period of time. The predefined period of time preferably may amount to several minutes, especially three minutes, preferably two minutes, e.g., one minute. Preferably, the predefined time period may also amount to 40 seconds, for example 20 seconds, in particular 10 seconds.

If the driver assistance system must intervene in a vehicle operation or if the vehicle had an accident, the used data are copied from the volatile memory to a permanent and/or semi-permanent memory according to a step 507, so that they are advantageously still available for analysis or evaluation even if an onboard electrical system of the vehicle malfunctions, for example, and thus is no longer able to provide the volatile memory with current, so that the data stored therein are lost.

In step 507, it may be provided, in particular, that the data stored in the volatile memory are transmitted to an external memory device, either in addition or as a replacement.

According to a step 509, the data used, which are still stored in the volatile memory, are transmitted to an external memory device regardless of an accident or regardless of an intervention of the driver assistance system, the transmission taking place following the predefined time interval. This advantageously increases a data redundancy.

According to a step 511, it may be provided that the stored data, e.g., the data in the permanent or semi-permanent memory and/or in the external memory device, are deleted if the vehicle did not have an accident.

In one specific embodiment (not shown), the received data are checked and confirmed for authenticity and/or integrity and/or consistency of the data or data sources, such as the environmental sensors, for instance.

In summary, the present invention advantageously allows an accident analysis, especially also a retroactive accident analysis, based on data that were used by a driver assistance system.

What is claimed is:

1. A method for operating a driver assistance system of a vehicle, comprising:
receiving data transmitted to the vehicle;
using the received data for a decision as to whether or not the driver assistance system is to provide a driver assistance function; and
archiving the used data.

2. The method as recited in claim 1, wherein only those data are archived that were used in a time interval that includes an instant at which the driver assistance function was made available.

3. The method as recited in claim 1, wherein the archiving includes storing the used data in a memory device situated inside the vehicle.

4. The method as recited in claim 3, wherein the memory device includes a volatile and a permanent memory, the data being stored in the volatile memory and copied from the volatile to the permanent memory when the driver assistance function is made available.

5. The method as recited in claim 1, wherein the archiving includes transmitting the used data to an external memory device situated externally to the vehicle.

6. A device for operating a driver assistance system of a vehicle, comprising:
a receiver to receive data transmitted to the vehicle; and
an archiver unit to archive the data that were used for a decision as to whether or not a driver assistance function is to be provided.

7. The device as recited in claim 6, wherein the archiver unit has a memory device which includes a volatile and a permanent memory.

8. The device as recited in claim 6, wherein the archiver unit has a transmitter to transmit the used data to an external memory device situated externally to the vehicle.

9. A system for a vehicle, comprising:
a driver assistance system; and
a device configured to operate the driver assistance system, the device including a receiver to receive data transmitted to the vehicle, and an archiver unit to archive the data that were used for a decision as to whether or not a driver assistance function is to be provided.

10. The system as recited in claim 9, further comprising:
an external memory device situated externally to the vehicle to store the archived data.

11. A computer readable storage medium storing a computer program for operating a driver assistance system, the program having program code which, when executed by a device, causes the device to perform the steps of:
receiving data transmitted to the vehicle;
using the received data for a decision as to whether or not the driver assistance system is to provide a driver assistance function; and
archiving the used data.
